(19) United States
(12) Patent Application Publication
(10) Pub. No.: US 2024/0211335 A1
(43) Pub. Date: Jun. 27, 2024

(54) METHOD OF IDENTIFYING A SYSTEM-WIDE FAILURE AND SYSTEM THEREFOR

(71) Applicant: Swish AI Ltd., Tel Aviv (IL)

(72) Inventors: Gadi WOLFMAN, Tel Aviv (IL); Arnon YAFFE, Tel Aviv (IL); Oren MIARA, Tel Aviv (IL)

(21) Appl. No.: 18/535,320

(22) Filed: Dec. 11, 2023

Related U.S. Application Data
(60) Provisional application No. 63/386,991, filed on Dec. 12, 2022.

(51) Int. Cl. G06F 11/07

(52) U.S. Cl. CPC G06F 11/0781; G06F 11/0709; G06F 11/079; G06F 11/0793

(57) ABSTRACT

A computer-implemented method for identifying a potential system-wide failure in a computerized system is provided. The method includes receiving a plurality of tickets generated by users of the computerized system, wherein at least some of the tickets include data pertaining to system failures, classifying, based on the data, at least some of the tickets to respective one or more classification categories included in a hierarchical failure classification data structure comprising a plurality of classification categories, wherein each of the categories is associated with a system failure, wherein the data structure was generated using machine learning techniques applied to historical ticketing information including a plurality of historical tickets and corresponding system failures, monitoring the one or more categories to identify a potential system-wide failure; and in response to identifying a potential system-wide failure, performing an action.

### TECHNICAL FIELD

The presently disclosed subject matter relates to the field of Information Technology (IT) supporting computerized systems of an organization, and, more particularly, to monitoring failures occurring in the computerized systems.

### BACKGROUND

Computerized system failures in organizations are typically addressed by IT support teams. Users report these failures by generating tickets in a ticketing system. Tickets are managed by the ticketing system used to create, manage, and maintain lists of open tickets, and, optionally, also history of resolved tickets of previous failures. Optionally, the ticketing system can route the open tickets to the appropriate IT support team responsible for handling the specific failure.

Organizations often face a high volume of constantly generated tickets that need to be processed. To streamline the ticketing process, data structures are employed, including categories and sub-categories of system failures. When creating tickets, users can select a category and sub-category for the failure, where categories are associated with components and services accessible by the users of the system, or with failures in these components and services.

However, users might not always be aware of the actual failure and could assign a category based on what they observe in the system. Consequently, the ticket may be routed to the wrong IT support team, leading to delays in resolving the issue. Moreover, users do not consistently provide detailed information about the failure, often opting for broad categorizations like “miscellaneous” or “other,” along with a brief description. Consequently, there is a need for a more accurate mapping of tickets to the specific categories associated with the correct system failures.

Additionally, multiple system failures in different components of the system may result in separate tickets being generated by different users. These seemingly isolated failures may, in reality, be symptoms of a broader system failure that affects multiple components. These separate tickets may be handled by different IT support teams, and there might be a lack of communication between them, leading to a failure to identify the larger underlying issue. Hence, there is a need for improved monitoring to identify such interrelated failures and address the root cause efficiently.

### GENERAL DESCRIPTION

The challenge of managing tickets in a large organization with numerous users and complex computerized systems can be burdensome and lead to resource and time wastage. In many organizations where ticketing systems are implemented, users are required to choose a category for the system failure they are experiencing, such as software, hardware, or mobile issues. Additionally, they have the option to select sub-categories, like specific software programs if they have chosen “software” as the main higher category. These sub-categories may include office programs, messaging programs, financial programs, and others. The ticketing system continuously generates and handles these tickets.

In smaller organizations, the IT support team manually prioritizes and resolves tickets, typically following a first-come-first-serve or priority-based approach. However, in larger organizations with multiple IT support teams specialized in different areas, the tickets may be automatically routed to the dedicated teams based on the categories selected by the users. This automation streamlines the ticket assignment process and ensures that each support team receives the relevant tickets according to their expertise.

A system-wide failure can occur when an entire system or a significant part of it becomes dysfunctional or unavailable, impacting the operation of multiple interconnected components and processes within the system. This kind of failure can lead to widespread disruptions in the system's normal operation. For instance, in a computerized organization, a system-wide failure might occur as a server going down, affecting various software components hosted on it, such as applications or VPN servers enabling users to connect to cloud-based applications. Consequently, these software components will not function until the server issue is resolved.

In typical cases, users may face difficulties accessing or using these software components and might submit multiple tickets specifically related to these individual components. Unfortunately, the users may not realize that the underlying problem lies with the server. Consequently, these tickets could be routed to different IT support teams, potentially lacking effective communication between them. This can result in each team independently handling the tickets, focusing solely on the software component, and failing to recognize the larger system-level problem.

The inability of each IT support team to see the complete picture can lead to a waste of both time and financial resources for the organization. The time taken to resolve the issue might be prolonged, and the non-functional software components contribute to further losses. Therefore, it is crucial for organizations to identify and address system-wide failures promptly, to minimize the impact on both operations and resources, and to bulk close failures pertaining to a system-wide failure, instead of independently handling each of them. Certain embodiments of the presently disclosed subject matter facilitate identifying system-wide failures when they occur, and, in some cases, anticipating them before they occur.

In known systems, organizations may employ specialized monitoring tools to proactively anticipate system-wide failures by continuously evaluating the state and performance of their systems. However, these tools are often tailored to specific software components, and do not possess the capability to identify and alert on system-wide failures when manifested as separate software components becoming non-functional from the users' perspective.

According to certain embodiments of the presently disclosed subject matter, identification of a potential system-wide failure in a computerized system is provided. An organization may use a hierarchical failure classification data structure, referred to herein and below as a “classification data structure”, comprising a plurality of classification categories and sub-categories of system failures. Each of the categories and sub-categories in the classification data structure may be associated with a system failure, for example, a category pertaining to a service in the organization may be associated with a possible failure in that service.

The classification data structure can coexist alongside any pre-existing hierarchical failure ticketing data structure that the organization has already implemented for managing organization tickets. In some cases, the classification data structure may include some different categories than those of the pre-existing ticketing data structure. For example, the classification data structure may also include a new level of more granulated sub-categories than the pre-existing ticketing data structure, these granulated sub-categories being associated with more focused system failures. In run-time mode, during regular operation of the systems, users may constantly generate new tickets. A user generating a new ticket may associate the ticket with a pre-existing failure category in the pre-existing ticketing data structure. In some cases, the tickets may be classified in the classification data structure, instead of or in addition to their association of failures by users in the pre-existing ticketing data structure.

Classification of a new ticket can be done, e.g., based on ticketing information in the tickets, such as the free text included in the tickets. The granulated sub-categories were pre-generated, e.g. in an on boarding stage, and were selected to be included in the classification data structure, such that the nature of the traffic of tickets being routed to the granulated sub-categories during run-time operation may be indicative of a potential system-wide failure. The nature of traffic of tickets in the granulated sub-categories, e.g., the number of tickets classified into a category within a certain period of time, may therefore be repeatedly monitored, and in case some anomaly in the traffic is detected, an action may be taken to identify whether a system-wide failure has occurred.

For illustration, assume that the organization uses several separate collaboration and communication cloud-based tools such as “Teams”, “Slack”, and “Zoom”. These cloud-based tools are accessed by employees though one or more VPN servers hosted on a particular server. Yet, for business reasons, separate IT support teams are assigned to handle each of these tools. The pre-existing ticketing data structure may implement categories of software and sub-categories related to each of these tools. The classification data structure may include another level of granulated sub-categories indicating specific problems in each of these tools, for example, “access problem” or “audio/video problems”. These granulated sub-categories may, by themselves, be associated with an additional layer of even more granulated categories such as “Microphone related issues” or “Video quality” relating to the sub-category of an “audio/video problems”.

In case of a system-wide failure pertaining to the server having gone down, during run-time operation, tickets may be generated by users pertaining to the software tools. A first ticket may assign a category of “Teams” while including free text of “can't access the program”. Another, second ticket, may be opened, under the category of “Slack” with free text of: “doesn't work”. Many other tickets may be opened with similar text, resulting in the categories of “Teams” and “Slack” being filled up with tickets. Additional tickets may be issued under these categories, which are not related to this failure, such as a user who has forgotten his password and cannot access the tool, or another user who requests another license to use the tool, both failures unrelated to the current system-wide failure of the server going down on which the VPN servers are located and now cannot be accessed. The tickets may be routed to different IT support teams who will then try to independently resolve the failure in each of the tools, without being of another similar failure of total lack of access to another tool in the organization. The classification data structure can implement another layer of categories, which in this case can include new sub-categories of a “lack of access” under each of the categories of the software tools. The tickets pertaining to the lack of access may be classified, in real time, to the respective sub-categories in the classification data structure. In some examples, monitoring the sub-categories and identifying an anomaly, such as a sudden spike of tickets routed to one or more particular “lack of access” categories in the classification data structure, may indicate of similar problems of lack of access in several tools. Optionally, considering also any pre-determined relation between several separate sub-categories, such as that both hosted on the same server, may indicate a potential system-wide failure in the server itself. A suitable indication may be provided to a certain IT support team, which may then consider first the option of the server going down, instead of having numerous IT support teams attempting to resolve separate failures for each of the users, without any chance of success, unless eventual sharing of information occurs.

Hence, it is advantageous to implement and make use of a data structure that includes granulated sub-categories, each associated with focused sub-categories, compared to categories included in pre-existing ticketing data structures, currently implemented in organizations, as monitoring the nature of traffic of tickets to these granulated categories may assist in identification of a potential system-wide failure, which could not have been detected on the pre-existing categories.

According to a first aspect of the presently disclosed subject matter, there is provided a computer-implemented method for identifying a potential system-wide failure in a computerized system, comprising:
receiving a plurality of tickets generated by users of the computerized system, wherein at least some of the tickets include data pertaining to system failures;
classifying, based on the data, at least some of the tickets to respective one or more classification categories included in a hierarchical failure classification data structure comprising a plurality of classification categories, wherein each of the categories is associated with a system failure, wherein the data structure was generated using machine learning techniques applied to historical ticketing information including a plurality of historical tickets and corresponding system failures;
monitoring the one or more categories to identify a potential system-wide failure; and
in response to identifying a potential system-wide failure, performing an action.

In addition to the above features, the computer-implemented method according to this aspect of the presently disclosed subject matter can optionally comprise in some examples one or more of features (i) to (xx) below, in any technically possible combination or permutation:
i. Wherein the tickets are associated by the users with pre-existing categories included in a pre-existing hierarchical failure data structure comprising a plurality of pre-existing categories, each associated with a pre-defined system failure.
ii. Wherein the pre-existing ticketing data structure and the classification data structure are identical.
iii. Wherein at least one of the classification categories does not correspond to any of the pre-existing categories.
iv. Wherein monitoring at least some of the pre-existing categories is insufficient to identify a potential system-wide failure.
v. Wherein the classification data structure comprises a plurality of hierarchical levels of main classification categories, each main category being associated with a respective main classification system failure, wherein at least one of the main classification categories in a top level has an associated plurality of related focused classification sub-categories in one or more lower levels, wherein at least one of the focused classification sub-categories is associated with a focused classification system failure, wherein at least one of the focused classification sub-categories does not correspond to any of the pre-existing categories.
vi. Wherein the classifying is performed using an Artificial Intelligence (AI) model.
vii. Wherein the classifying further comprises, for each ticket:
obtaining a confidence value indicative of the level of confidence that the ticket should be classified to the respective category;
obtaining a pre-defined threshold associated with the respective category; and
classifying the ticket to the category in response to the confidence level exceeding the predetermined threshold.
viii. Wherein the monitoring comprises:
determining values of one or more parameters pertaining to classification of the tickets to the at least one classification category;
based on the values, identifying a potential system-wide failure.
ix. Wherein the parameters are selected from a group comprising: volume, frequency, an hour of the day, and history of past tickets classified to the classification categories, one or more pre-defined rules, location in which the ticket was generated, or a combination thereof.
x. Wherein the at least one parameter is the volume, and wherein identifying the potential system-wide failure comprises:
detecting an anomaly; and
identifying, based on the anomaly, the potential system-wide failure.
xi. Wherein the anomaly is a spike.
xii. Wherein, in response to detecting the spike, the method comprises:
monitoring at least one related category to detect a second spike; and
in response to detecting a second spike, identifying a potential system-wide failure.
xiii. Wherein, prior to identifying the potential system-wide failure, the method further comprises:
in response to detecting the spike, obtaining additional indication from at least one component of the computerized system, configured to monitor processes running on the computerized system; and identifying the potential system-wide failure, based on the spike and the additional indication.
xiv. Wherein monitoring the categories is performed selectively.
xv. Wherein monitoring the categories is repeatedly performed.
xvi. Wherein monitoring the categories is repeatedly performed based on a moving time interval.
xvii. Wherein the data structure can be updated over time.
xviii. Wherein the data structure is updated based on new ticketing information.
xix. Wherein the historical tickets are generated by users of the computerized system.
xx. Wherein the historical tickets are generated by other users of another, similar, computerized system.

The presently disclosed subject matter further comprises a computerized system for identifying a system-wide failure in a computerized system, the system comprising a processing and memory circuitry being configured to execute a method as described above with reference to the first aspect, and may optionally further comprise one or more of the features (i) to (xx) listed above, mutatis mutandis, in any technically possible combination or permutation.

The presently disclosed subject matter further comprises a non-transitory computer readable storage medium tangibly embodying a program of instructions that, when executed by a computer, cause the computer to perform a method as described above with reference the first aspect, and may optionally further comprise one or more of the features (i) to (xx) listed above, mutatis mutandis, in any technically possible combination or permutation.

According to a second aspect of the presently disclosed subject matter there is provided a computer-implemented method for facilitating identifying a system-wide failure in a computerized system, comprising:
obtaining historical ticketing information including a plurality of historical tickets and corresponding system failures, wherein each of the historical tickets is generated by users of the computerized system and at least some of the historical tickets are associated by the users with pre-existing categories included in a pre-existing hierarchical failure data structure comprising a plurality of pre-existing categories, each associated with a pre-defined system failure;
using machine learning techniques applied to historical ticketing information to process the tickets and correlate them to one or more classification categories, wherein each of the classification categories is associated with a respective classification system failure; and maintaining a classification hierarchical failure data structure comprising the one or more classification categories;
wherein monitoring the classification categories during a run-time process facilitates identification of a potential system-wide failure.

In addition to the above features, the system according to the second aspect of the presently disclosed subject matter can comprise the following feature:
i. The method further comprising:
receiving new ticketing information pertaining to new tickets generated by users of the computerized system; and
updating the data structure based on the new ticketing information.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates a generalized diagram of an environment 100, in accordance with certain embodiments of the currently presented subject matter;

FIG. 2A illustrates an example of a pre-existing hierarchical failure data structure 142 and hierarchical failure classification data structure 152, according to certain embodiments of the presently disclosure subject matter;

FIG. 2B illustrates another example of a hierarchical failure data structure, according to certain embodiments of the presently disclosure subject matter;

FIG. 3 illustrates a failure classification system 150, in accordance with certain embodiments of the presently disclosed subject matter;

FIG. 4 illustrates a generalized flow-chart method 400 for identifying a potential system-wide failure in a computerized system, in accordance with certain embodiments of the presently disclosed subject matter;

FIG. 5 illustrates an example of a repeated execution of several steps, according to certain embodiments of the presently disclosure subject matter; and

FIG. 6 illustrates a generalized flow-chart method 600 for facilitating identifying a system-wide failure in a computerized system, in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the following discussions, it is appreciated that throughout the specification discussions utilizing terms such as “receiving”, “classifying”, “generating”, “identifying”, “monitoring”, “performing”, “associating”, “obtaining”, “determining”, “identifying”, “detecting”, “processing”, “maintaining”, “updating”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities, including a personal computer, a server, a computing system, a communication device, a processor or processing unit (e.g., digital signal processor (DSP), a microcontroller, a microprocessor, a field programmable gate array (FPGA), an application specific integrated circuit (ASIC), etc.), and any other electronic computing device, including, by way of non-limiting example, computerized systems or devices such as user devices, organization computerized system 120, failure classification system 150, and PMC 310, disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

Usage of conditional language, such as “may”, “might”, or variants thereof, should be construed as conveying that one or more examples of the subject matter may include, while one or more other examples of the subject matter may not necessarily include, certain methods, procedures, components, and features. Thus, such conditional language is not generally intended to imply that a particular described method, procedure, component, or circuit is necessarily included in all examples of the subject matter. Moreover, the usage of non-conditional language does not necessarily imply that a particular described method, procedure, component, or circuit, is necessarily included in all examples of the subject matter. Also, reference in the specification to “one case”, “some cases”, “other cases”, or variants thereof, means that a particular feature, structure, or characteristic, described in connection with the embodiment(s), is included in at least one embodiment of the presently disclosed subject matter. Thus the appearance of the phrase “one case”, “some cases”, “other cases”, or variants thereof, does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately, or in any suitable sub-combination.

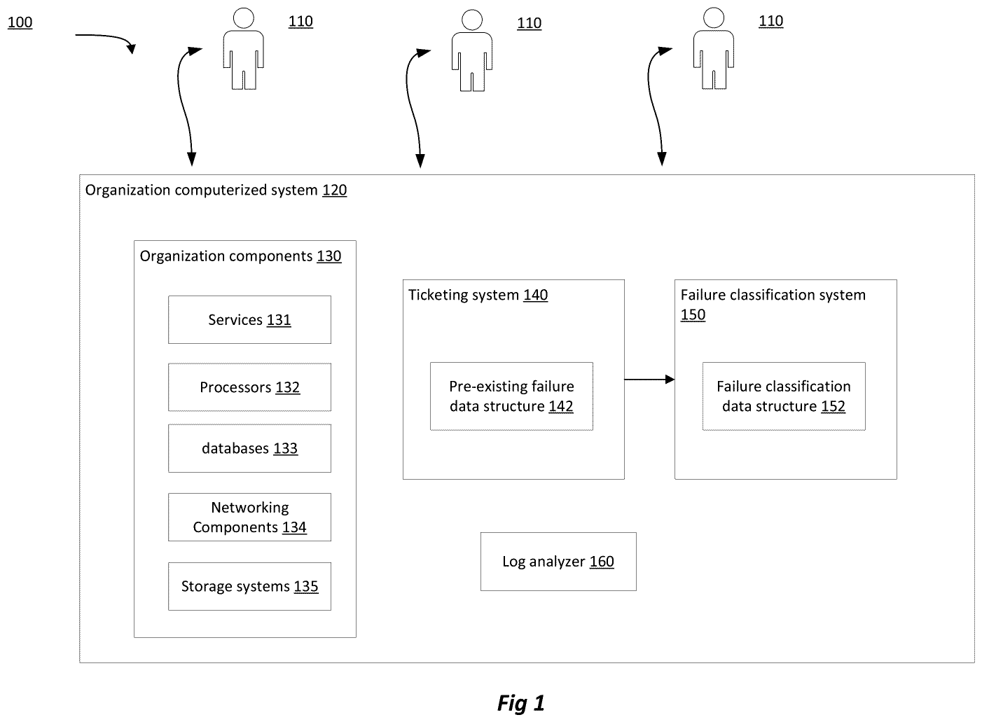

Bearing this in mind, attention is drawn to FIG. 1 illustrating a generalized diagram of an environment 100, in accordance with certain embodiments of the currently presented subject matter. Environment 100 is configured to enable a computer-implemented method for identifying a potential system-wide failure in an organization computerized system 120.

In some cases, within environment 100, multiple entities may exist, all operatively interconnected, and which may communicate through a network. The environment 100 may comprise a plurality of users 110 who can interact with the organization computerized system 120, and to utilize organization components 130 and ticketing system 140. User 110 can be human users related to the organization such as employees, management staff etc. A user 110 can also include a non-human user operating the system, such as a bot configured to perform automated tasks, or machines which are configured to generate failure messages when failures occur. In some examples, some users prefer to call the contact center instead of opening a ticket, hence an agent in the call center will write the complain on behalf of the user experiencing the system failure, while constituting a user 110 for such cases.

A user 110 can access the organization components 130, as well as to the ticketing system 140 using his personal device (not shown), such as a desktop organization computer or his mobile device, allowing the user 110 to communicate or use some or all of components 130. Organization components 130 can include any computerized components including non-limiting examples of various services 131, processors 132, databases 133, networking components 134, and storage systems 135.

Organization computerized system 120 can also include a log analyzer 160 configured to collect, parse, and analyze log files, including events which have occurred in organization computerized system 120. Input from the log analyzer 160 can be used when identifying a system-wide failure.

The ticketing system 140 is configured to allow users to generate tickets related to various system failures. These failures may involve problems with accessing and communicating with components 130, issues with the user's personal devices, and user requests like accessing new software or adding new users, among others. The ticketing system 140 is configured to keep track of open tickets, including those that have been generated and are currently pending in the queue for processing, or are being processed. Optionally, it may also maintain a history of resolved tickets from past failures. In some examples, the ticketing system 140 can route the open tickets to the appropriate IT support team (not shown) responsible for handling the specific failure.

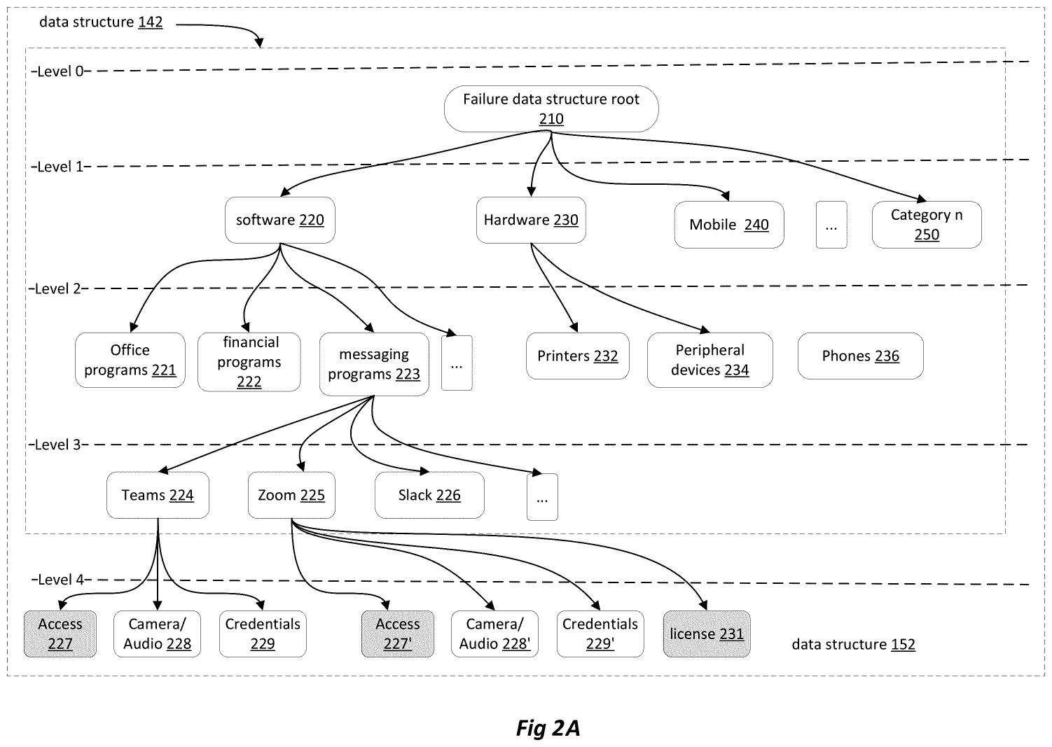

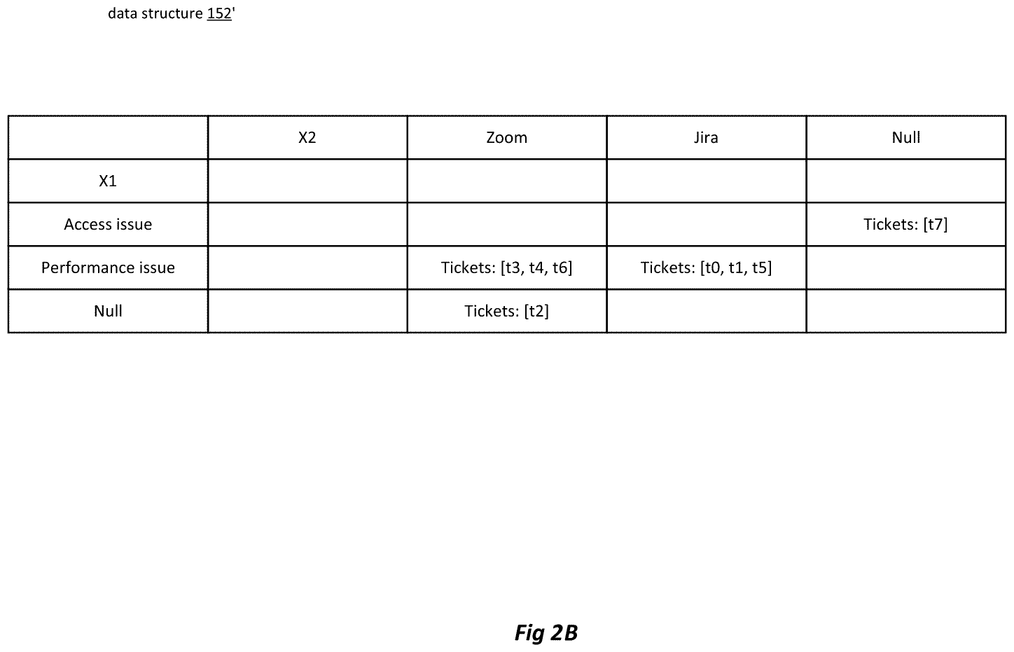

In some examples, the ticketing system 140 may implement a pre-existing hierarchical failure data structure 142. Reference is made to FIG. 2A illustrating an example of a pre-existing hierarchical failure data structure 142, according to certain embodiments of the presently disclosed subject matter. The pre-existing ticketing data structure 142 may be implemented as a hierarchical failure data structure comprising levels of categories, illustrated by level 0, level 1 . . . , where each level comprises a plurality of categories. Each category may be associated with a pre-defined system failure. For example, level 1 includes a category of software 220. Selecting this category by the user 110 is indicative that the user indicates that there is a software failure. Level 3 includes a category of Teams 224. Selecting Teams 224 category by the user is indicative that the user has detected a failure in Teams software. In some examples, a first level of categories may include a plurality of levels of main categories. Each main category identifies a respective main system failure. As illustrated, the root is marked by failure data structure root 210. Level 1 comprises a main category software 220, a main category hardware 230, a main category mobile 240, and other optional categories represented by a main category n 250. In some examples, a main category in a top level has an associated related sub-category in one or more lower levels. A sub-category may identify a focused system failure sub-category indicative of a respective focused system failure. In some examples, the data structure 142 comprises a plurality of main categories, where at least one main category has a plurality of sub-categories. As illustrated, main category software 220 is associated with focused sub-categories office programs 221, financial programs 222, and messaging programs 223 in level 2 of the hierarchy. Main category hardware 230 is associated with focused sub-categories of printers 232, peripheral devices 234, and phones 236. In some examples, a sub-category can also be associated with one or more respective sub-categories in the next lower level, where the categories in the next lower level include even more focused system failures than the upper sub-category with which they are associated. For example, the messaging programs 223 category in level 2 is associated with focused sub-categories Teams 224, Zoom 225, and Slack 226, constituting more focused categories of messaging programs 223. Office programs 221 and financial programs 222 may also have sub-categories associated with them (not shown). A user that opens a new ticket may be presented with the first level of categories (level 1) in which he may select a category. Upon selection of a particular category, the next related level of categories (level 2) may be presented to him. The categories that will be presented to him are related to the category in which he selected a further level. This process may continue until the lower level of categories are presented to him. Then, the user 110 may add free text in the ticket to further describe the failure he has encountered. The levels and categories included in pre-existing ticketing data structure 142 illustrated in FIG. 2A are marked in a dashed line and may comprise levels 0-3.

Referring back to FIG. 1, in some cases, tickets issued by users 110 may be routed to failure classification system 150. System 150 may comprise a failure classification data structure 152 and is configured to classify the tickets to failure categories in the data structure 152. System 150 is configured to classify, in near real time, each ticket when generated, or may classify a plurality of tickets in bulks upon a pre-determined or dynamically changing time interval. System 150 may classify the tickets using data structure 152. Reference is made to FIG. 2A for describing data structure 152, in accordance with certain embodiments of the presently disclosed subject matter.

Similar to pre-existing ticketing data structure 142, classification data structure 152 may be a hierarchical failure data structure comprising levels of categories, where categories in an upper level identify main system failures and may be associated with sub-categories in lower levels, and each of the sub-categories may identify more a focused system failure. The levels and categories included in data structure 152 illustrated in FIG. 2A are marked in a second dashed line, and may comprise levels 0-4. Level 4 comprises additional pre-defined sub-categories, each identifying a more focused sub-category. For example, Teams sub-category may be associated with categories identifying more focused failures which may occur in Teams e.g., access failures 227, Camera/Audio 228, and Credentials 229. Zoom 225 sub-category may also be associated with sub-categories access failures 227′, Camera/Audio 228′, Credentials 229′, and license 231. Sub-categories 227-229, associated with sub-category Teams 224, may be similar to other sub-categories 227′-229′ associated with another sub-category Zoom 225, partially identical, or different, such as sub-category license 231 which do not have corresponding sub-category in sub-categories 227-229.

FIG. 2A illustrates that pre-existing ticketing data structure 142 is a subset of classification data structure 152. However, this is not binding, and those skilled in the art will readily appreciate that the teachings of the presently disclosed subject matter are, likewise, applicable to any classification data structure 152 that is generated with any categories that are generated, e.g., by machine learning techniques as detailed further below. Thus, classification data structure 152 may include all, partial, or different categories than those included in pre-existing ticketing data structure 142, and may be displayed to the user 110 in ticketing system 140 partially or entirely, optionally, instead of the pre-existing ticketing data structure, while replacing the pre-existing ticketing data structure 142 with more efficient and accurate data structure and categories, enhancing identifying a potential system-wide failure during run-time operation.

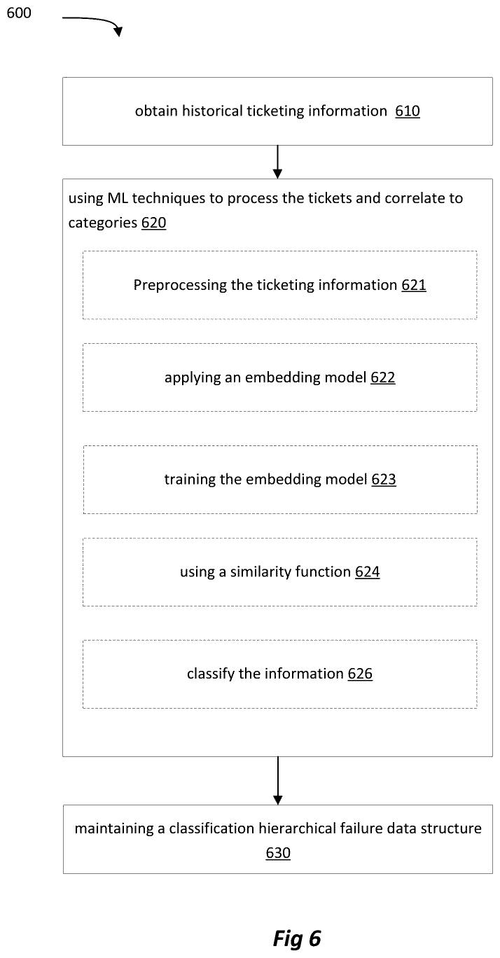

In some examples, classification data structure 152 may be generated a preliminary onboarding process using machine learning techniques such as Self-Supervision with contrastive learning and/or Unsupervised methods such as hierarchical similarities between embedded tickets in high dimensional space. Generating the classification data structure 152 can include applying machine learning techniques to historical ticketing information, including a plurality of historical tickets and corresponding system failures. Further details of the generation process are included in FIG. 6 below.

One purpose of generating data structure 152 in a preliminary onboarding process results from the need to identify a potential system-wide failure during run-time operation. identifying a potential system-wide failure may be achieved by monitoring the categories of data structures in an organization during run-time operation. Monitoring existing categories such as those included in a pre-existing data structure 142 is insufficient to identify a potential system-wide failure, e.g., since the categories are not sufficiently indicative, and may include various failures, some of which may not relate to a systemwide failure, for examples, if a user 110 wishes to add another user in the system. In order to monitor the nature of traffic of tickets to categories in a data structure and identify an anomaly, such that a potential system-wide failure may occur, tickets that relate to system failure which could not be part of a system-wide failure should be separated from other tickets and classified to different categories. Generating and maintaining one or more additional levels of focused categories in the data structure 152, as opposed to data structure 142, facilitates in identifying a potential system-wide failure during run-time operation.

Monitoring the sub-categories to detect occurrence of a system-wide failure can be performed on one or more of the categories included in data structure 152, in various upper levels and/or lower levels of the data structure 152.

In some examples, once data structure 152 is generated, it can replace data structure 142 provided to users 110 such that they can generate tickets based on categories and sub-categories included in data structure 152, such that data structure 142 and data structure 152 are now identical. In some examples, only a sub-data structure of 152 may be provided to users 110, and users 110 do not see the entire data structure 152. This may occur e.g., if data structure 152 is granulated in a sense that it includes too many categories and sub-categories which may be cumbersome to the users 110. Yet, clustering new tickets during the run-time process can occur in real-time on the entire categories of data structure 152, irrespective of the data structure presented to the users 110 and the categories they selected when opening the tickets.

In some examples, data structure 152 includes at least one category which does not correspond to any of the categories included in data structure 142, such as sub-categories 227-229 and 227′-231.

In some examples, data structure 152 can be updated over time. For example, data structure 152 can be updated based on new ticketing information and eventual failures that occurred in the system. Alternatively, or additionally, data structure 152 can be updated following an input that was received from a relevant person in the organization, e.g., an IT support team member who wishes to change the categories.

Those versed in the art will realize that the classification data structure 152 illustrated in FIG. 2A in accordance with certain embodiments of the presently disclosed subject matter can include fewer or additional levels and/or categories/sub-categories. For example, one or more sub-categories in level 4 can be associated with a plurality of focused sub-categories in next level 5. Also, those versed in the art will realize that the term data structure is meant in the broad sense, and may be implemented by various designs of data structures, for example, in a form of an independent multi-dimensional structure (multidimensional Matrix data structure). FIG. 2B illustrates an alternative data structure 152′ in the form of a multidimensional Matrix data structure, in accordance with certain embodiments of the currently presented subject matter. In cases where multidimensional data structure 152′ is used, the categories of the data structure 152′ are conditional. The user 110 may be presented with several categories, including e.g., the category zoom. Once the user 110 selects Zoom, then subcategories are filled with predefined list that is under Zoom. A multidimensional data structure 152′ may include independent X₁, X₂, . . . Xₙ dimensions, where a category Xᵢ is neither on top of Xⱼ nor under it. Unlike the hierarchical structure 152 illustrated above, in a multidimensional data structure 152′, a category X₁ can be selected without selecting category X₂ (e.g., ticket t2) or category X₂ can be selected without category X₁ (e.g., t7). The multidimensional data structure 152′ can be expanded to higher dimensions, such as x3 (3D dimensions) and so forth. The monitoring of the traffic of tickets classified into categories can be done in a similar manner to the monitor of the traffic in the categories of data structure 152, as described above and further below. Those versed in the art would realize that any reference to data structure 152 throughout the description is also applicable to data structure 152′.

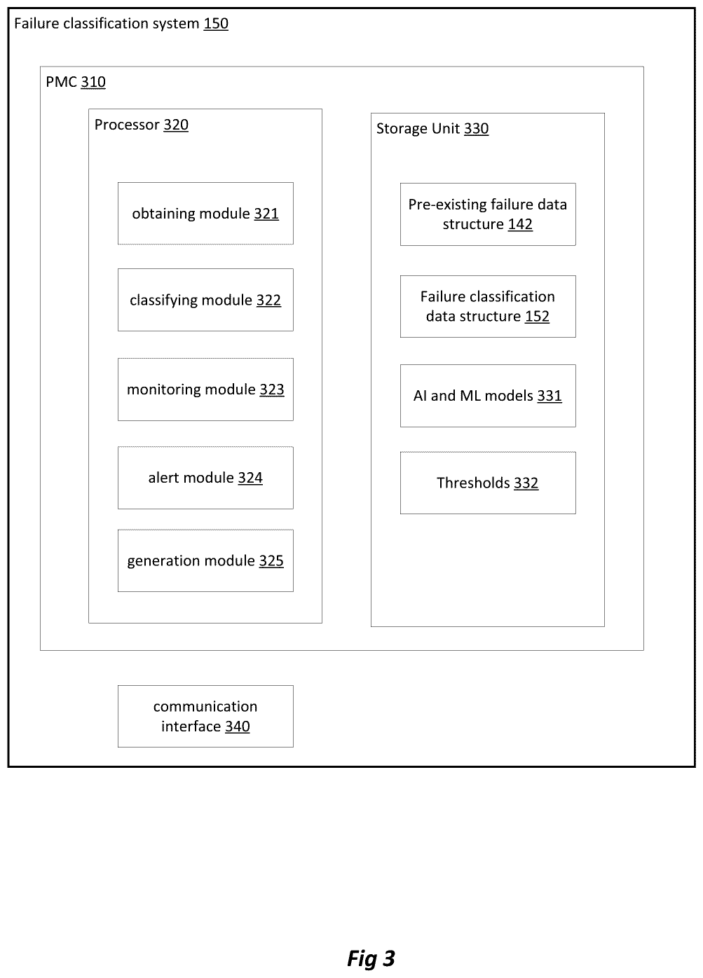

Attention is drawn to FIG. 3 illustrating a failure classification system 150, in accordance with certain embodiments of the presently disclosed subject matter. System 150 for a computer comprises several components which operatively communicate with each other and is configured for identifying a potential system-wide failure.

System 100 comprises a processor and memory circuitry (PMC) 310 comprising a processor 320 and a Storage Unit 330. System 100 further comprises a communication interface 340 enabling system 100 to operatively communicate with external devices and storages, if necessary. The processor 320 is configured to execute several functional modules in accordance with computer-readable instructions implemented on a non-transitory computer-readable storage medium such as storage unit 330. Such functional modules are referred to hereinafter as comprised in the processor 320. The processor 320 can comprise an obtaining module 321, a classifying module 322, a monitoring module 323, an alert module 324, and a generation module 325.

Storage Unit 330 may store failure classification data structure 152 (or alterative multidimensional data structure 152′) which may be used by the processor 320 to classify tickets and monitor the traffic of the tickets in categories in the data structure 152. Storage Unit 330 may also store a pre-existing failure data structure 142 if implemented by organization computerized system 120. Storage Unit 330 may also store one or more Artificial Intelligence (AI) and Machine Learning (ML) models 331 used to classify new tickets during run-time operation, and generate the classification data structure 152 during the onboarding process. Some examples of ML models and Data structure stored in ML models 331 can include models that are stored and used during the onboarding process of generating the classification data structure and/or during runtime in which new tickets are classified such as machine learning models that are based on the Transformers architecture such as BERT, Albert, BART, GPT etc., high dimensional representation, vectors, of tickets, the hierarchical representation of relations between vectors, known as linkage matrix and such. In some examples, different models are used for classifying new tickets and for generating the classification data structure 152.

Storage Unit 330 may also store thresholds 332 including a plurality of thresholds. The thresholds may be used for comparing with confidence values obtained from classifying tickets using the ML techniques.

In some examples, obtaining module 321 is configured to obtain a plurality of tickets generated by users of the computerized system, e.g., by receiving the tickets or data indicative of tickets from ticketing system 140. Obtaining module 321 is further configured to obtain any additional information from components of the system, for example an additional indication when a spike is detected, to identify whether a potential system-wide failure has occurred. Classifying module 322 is configured to classify tickets into categories in classification data structure 152, e.g., using an AI model stored in AI models 332, based on data included in the tickets.

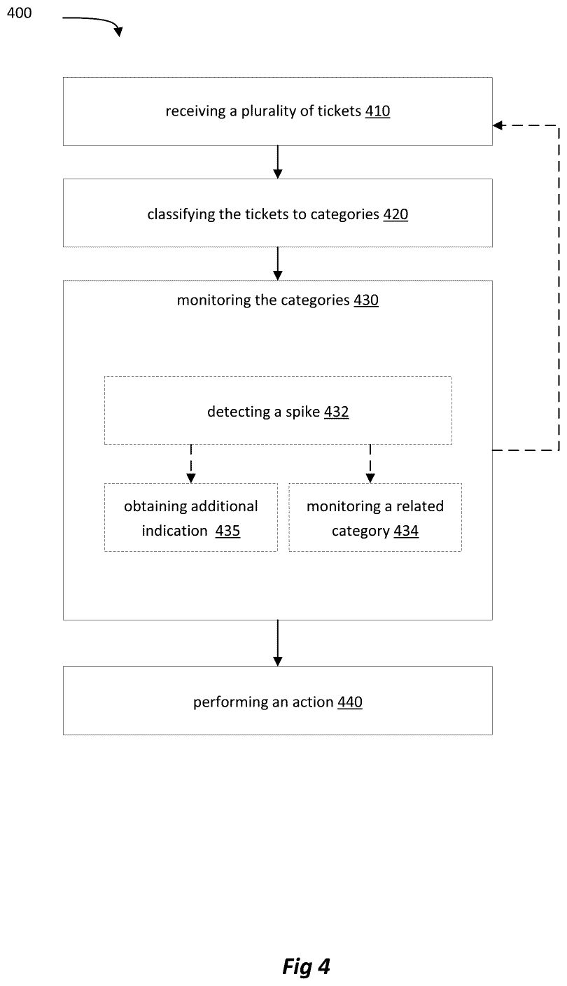

Monitoring module 323 is configured to monitor the categories and sub-categories in classification data structure 152 to identify a potential system-wide failure, and in case a potential system-wide failure is identified, to communicate to alert module 324 to perform an action. Further details of the classification and monitoring process are described below with respect to FIG. 4.

Generation module 325 is configured to generate, using ML models stored in ML models 331, the classification data structure 152, and optionally, to update it over time.

It is noted that the teachings of the presently disclosed subject matter are not bound by the organization computerized system 120 or by failure classification system 150 described with reference to FIGS. 1-3. Equivalent and/or modified functionality can be consolidated or divided in another manner and can be implemented by any appropriate combination of software with firmware and/or hardware and executed on a suitable device. Failure classification system 150 can be part of organization computerized system 120 or can be operatively connected to it. Also, those skilled in the art will also readily appreciate that the databases, such as storage unit 330, can be consolidated or divided in other manner; databases can be shared with other systems or be provided by other systems, including third party equipment.

Referring to FIG. 4, there is illustrated a generalized flow-chart method 400 for identifying a potential system-wide failure in a computerized system, in accordance with certain embodiments of the presently disclosed subject matter. The operations of FIG. 4 are described with reference to elements of failure classification system 150. However, this is by no means binding, and the operations can be performed by elements other than those described herein.

In some cases, a plurality of tickets generated by users 110 of the computerized system 120 are received by ticketing system 140. In the example of a user 110 experiencing problems accessing Teams software, the user 110 generates a ticket in the ticketing system 140. The user 110 may assign the ticket with a category in the pre-existing data structure 142 or in the classification data structure 152 if presented to him, whichever is used by ticketing system 140. Alternatively, or additionally, the tickets may also be assigned with category by a third party other than the user 110, such as an agent, or automatically by ticketing system 140. In relation to FIG. 2A, the user 110 may open the ticket under Teams 224 sub-category included in data structure 142, title it with “teams,” and include the text “can't sign in” in the free text box. The ticket may include data pertaining to the system failures. The data may include the category associated with the ticket, a title given by the user 110 and may also include free text reading: “can't sign in”, and optionally, assign priority to the ticket. In addition, the data may include metadata of the ticket, for example, the hour at which the ticket was generated by the user 110, the current status of the ticket or the user 110 identity. Those skilled in the art will readily appreciate that the teachings of the presently disclosed subject matter are, likewise, applicable to additional data that may be extracted from the ticket.

In similar manner, plurality of users 110 may generate a plurality of tickets in ticketing system 140. Obtaining module 321 can receive the tickets from ticketing system 140 (block 410). At least some of the obtained tickets may include data pertaining to system failures. Data pertaining to the system failures, including e.g., as described above, the category, title, free text and metadata of the ticket, may be extracted by obtaining module 321, e.g., using known techniques.

Based on the extracted data, classifying module 322 can classify the tickets to classification categories (block 420). Classifying module 322 can classify only some of the tickets while ignoring others, e.g., in cases of identifying duplicate tickets being generated for the same failure by the same user, or since it is clear from ticket (based on the identity of the user 110, or for another reason) that the failure experienced by the user 110 absolutely cannot be caused by a system-wide failure, or for other reasons justifying not classifying all tickets.

The tickets can be classified into categories included in a hierarchical failure classification data structure comprising a plurality of classification categories such as classification data structure 152. Each of the categories can be associated with a system failure, such as categories shown in FIG. 2A in levels 0-3, but in particular also categories and sub-categories included in level 4 in FIG. 2A including sub-categories 227-229, 227′-229′, and 231. Classifying module 322 can classify the tickets into classification categories in the classification data structure 152 in addition to any classification made by the user 110 when generating the ticket or to any classification automatically made by ticketing system 140 using pre-existing ticketing data structures.

Classifying module 322 can classify the tickets to the categories using a pretrained self-supervised model AI model, such as one or more of the AI models stored in AI models 331. The process of training an AI model stored in AI models 331 in an onboarding process is described further below with respect to FIG. 6. Following is a description of classifying a new ticket to a category in data structure 152 using the trained AI model.

In order to classify a new ticket, the ticket entering the classification module will undergo preprocessing in which textual information, including the data pertaining to the system failures included in the ticket may be transformed and normalized using various functions like special symbol removal, predefined template removal, lemmatization and/or stemming, etc. Numerical and categorical features may be included in textual features derived from text in the ticket, such as the following numerical features: the number of words in the ticket, the number of sentences, the number of unique words, average word length, the average sentiment score of the ticket, or the following categorical features: the ticket's title, priority, status, user identity etc. as described previously with a dedicated prompt. Alternatively, ticket textual features can be excluded from the ticket, and get filled with mean value if missing or inferred using an additional AI model that is dedicated for that feature.

The transformed features of the ticket, resulted from the preprocessing process, may be processed by one or more pretrained self-supervised AI model. First, an embedding model to learn representations of the transformed features may be used. The embedding model may map features to high-dimensional vectors, resulting in a ticket transformed and output as a high dimensional vector (optionally, 512 dimension is used). Then, a similarity function, may be applied between a vector representing the ticket and multiple vectors that represent a group (in a category) within the classification data structure 152. Classifying a ticket into a specific category may be done based on the similarity score.

In some examples, the same set of features may go in parallel to additional supervised model that was trained on the same set of features and will output the likelihood of a given set of features to be in one of the categories in the data structure 142 or classification data structure 152. This part can be viewed as MOE (mixture of experts) where two techniques applied. The probability of the latter may be combined with the similarity of the first to improve the accuracy and performance of the AI models.

The classification process may output a category, in this case, in classification data structure 152, and a confidence value. As known in the art, the confidence value may be a number between 0 and 1, where 0 indicates no confidence, and 1 indicates complete confidence. When classifying a ticket, the confidence level may indicate the level of confidence, and the ticket should be classified to the respective category. In case a ticket is classified to a category with a low confidence value, it may be advisable not to classify the ticket to the category at all. The confidence value may be compared to a pre-defined threshold associated with the category, and the ticket should be classified to the category only if the confidence level exceeds a predetermined threshold. Hence, after applying the AI model to classify the ticket, in some examples, classifying module 322 can obtain the confidence value output from the classification, obtain a predetermined threshold associated with the category to which the ticket was classified, and classify the ticket to the category only in response to the confidence level exceeding the threshold.

Using confidence levels and thresholds to determine whether to classify a ticket to a certain category may be advantageous, as it achieves classification even in cases of low level of certainty, which facilitates later monitoring the categories to identify a potential system-wide failure. This is unlike other fields of technology, such as medical applications, demanding a much higher level of confidence to attain accurate and precise classifications, or when the input, i.e., the tickets, are machine-generated, whereas, in this case, the input is manually generated by users 110, such has human users 110. Also, different thresholds can be associated with different categories, which may reflect some different level of tolerance for different categories. As such, adaptive thresholds are advantageous, as rare cases may be associate with a lower threshold while a more frequent used category may be set with a higher threshold to mitigate false alarms.

In case a ticket is not classified to any of the categories with confidence levels that exceed the respective thresholds, then the ticket may be routed to a “basket” category. Tickets included in the basket category may indicate that a new failure has occurred which requires a new category to be defined and updated in the classification data structure 152. Alternatively, tickets in the basket category may be defined as exceptions which should not affect the nature of traffic in the other categories.

In many cases, based on the nature of the machine learning classification models, the models tend to emphasize one class only, as this is embedded within the loss function in the training process. Usually, a function called SoftMax is applied to the final layer of the model. The objective of this function is to bring to output as accurate as possible to hit that one category it belongs to (in the training set). However, ambiguity can emerge when two categories share very similar input, then instead of decisively saying it belongs to one category, the “scores” might be equally distributed to both categories. In such cases, each category may get scored. For many cases the system will choose one category, however, the scores can be kept, and can potentially be associated to more than one category. An example can be the following case. One SME (subject matter expertise) can have a different view over a problem or a category. Manager A wants to aggregate all the memory and hard disk issues a cross all servers, while Manager B would like to aggregate based on the server name, which for each one of the servers category there are plenty of issues. A ticket with specific server name can belong to both categories.

In some cases, monitoring module 323 can monitor the classification categories of classification data structure 152 to identify a potential system-wide failure (block 430). Monitoring the categories can include applying a monitoring algorithm to monitor the activity in categories, e.g., the tickets classified to the category and/or the nature of traffic of tickets being classified to the category. Categories and tickets classified to the categories can be scanned to determine values of one or more parameters pertaining to classification of the tickets to the categories, and, based on the value, identify a potential system-wide failure. Examples of parameters can include volume, frequency, the hour of the day, and history of past tickets classified to the classification categories, one or more pre-defined rules, location in which the ticket was generated, or a combination thereof. The categories can be scanned with respect to one or more selected parameters, or a combination thereof. For example, regular operation of the computerized system may expect a certain volume of tickets to be issued to each category. Monitoring volumes of tickets classified to the category can indicate if there is an anomaly, e.g., a deviation from the expected volume of tickets. In case an anomaly is detected, monitoring module 323 can identifying a potential system-wide failure. One example of an anomaly is a spike, e.g., a sudden and significant increase or rise in the volume of tickets classified to a category within a specific period. Block 432 illustrates that a spike is detected. A spike can indicate that many users 110 are encountering similar failures and issuing similar tickets. A sudden decrease in the volume of tickets, in cases where it should be generated, can also indicate an anomaly resulting in identifying a potential system-wide failure.

Monitoring module 323 can also monitor other parameters, where deviation from regular operation may result in deviation in the expected value of any one of the parameters. For example, if the frequency of tickets is higher in an unexpected time frame, the time of the day in which a certain volume of tickets was generated, e.g., tickets issued by bots during a time frame wherein it should not run, history of past tickets classified to the classification categories (such as nature of tickets classified to the category in the last scanning of the category. “Scanning” is autoregressive process where historical information may be weighted into mathematical formula e.g. exponential moving average or Autoregressive Integrated Moving Average (ARIMA) model or any other timeseries forecasting algorithm. The stationary or non-stationary model may then predict the next timestamp t+1, the deviation from the predicted, “expected” value can indicate anomaly/spike), one or more predefined rules, or a combination of any of the parameters. For example, a combination of medium frequency of tickets issued to a category during non-working hours may generate a trigger of identification of a potential system-wide failure, where the same frequency of tickets during working hours may not.

Non-limiting examples of pre-defined rules can include specific rules determined by the organization, such as rules based on specific users of the system, or during a specific time, e.g., during times wherein load on the system is expected (e.g., during certain events resulting in high activity of the users in the system), specific priorities e.g., to specific users of the system or to specific categories, for example, if the categories are crucial for the operation of the organization and even a low number of tickets issued in that category should trigger an identification of a potential system-wide failure event.

In some examples, selective monitoring can be applied, wherein only a subset of the categories is monitored, based on one or more predefined rules. The pre-defined rules can include monitoring only categories which received new tickets in pre-defined time intervals, monitoring a predefined list of categories more frequently than other categories, e.g., those that have a higher likelihood to indicate a potential system-wide failure, monitoring categories based on history of categories associated with a high number of previous system-wide failures, or any other considerations.

Selective monitoring can also involve analyzing distinct time intervals during which tickets were classified to different categories. For example, for a category A, monitoring module 323 will consider parameters of tickets issued in the last day for the purpose of identifying a potential system-side failure, whereas for category B, only tickets issued in the last hour will be considered. Selective monitoring is advantageous, e.g., in cases where certain categories may be related to system components which are of low use, and any ticket, even if issued for a longer duration, should be taken into consideration, whereas other categories are of high use, and regular operation of the organization expects frequent generation of tickets. In such cases, a shorter time interval will be considered.

In some examples, each of the procedures of classifying new tickets issued in the ticketing system 140 and/or monitoring the traffic in the categories can be done continuously and/or periodically, e.g., each time a new ticket is generated, when a certain volume of tickets is generated during a predefined period of time, in another predefined period of time, or responsive to predefined events (including scheduled events and events occurring in accordance with predefined periodicity). Classifying the tickets and/or monitoring frequency can also be dynamic. In periods anticipated to experience elevated system demand, such as during specific events, classifying and/or monitoring can be scheduled for more frequent execution. Conversely, during off-peak hours or days, monitoring can be scheduled at a lower frequency to conserve resources and minimize disruptions to regular operations. In such cases, the processor 320 can repeatedly execute the stages of receiving a plurality of tickets, classifying at least some of the tickets to respective classification categories and monitoring the categories. Such repeated execution is illustrated by a dashed line in FIG. 4 from block 430 to block 410. In order to monitor categories, in each execution the monitoring module 323 may consider tickets classified to each category in a moving time interval compared to previous execution. As explained, the time interval for various categories may also be different.

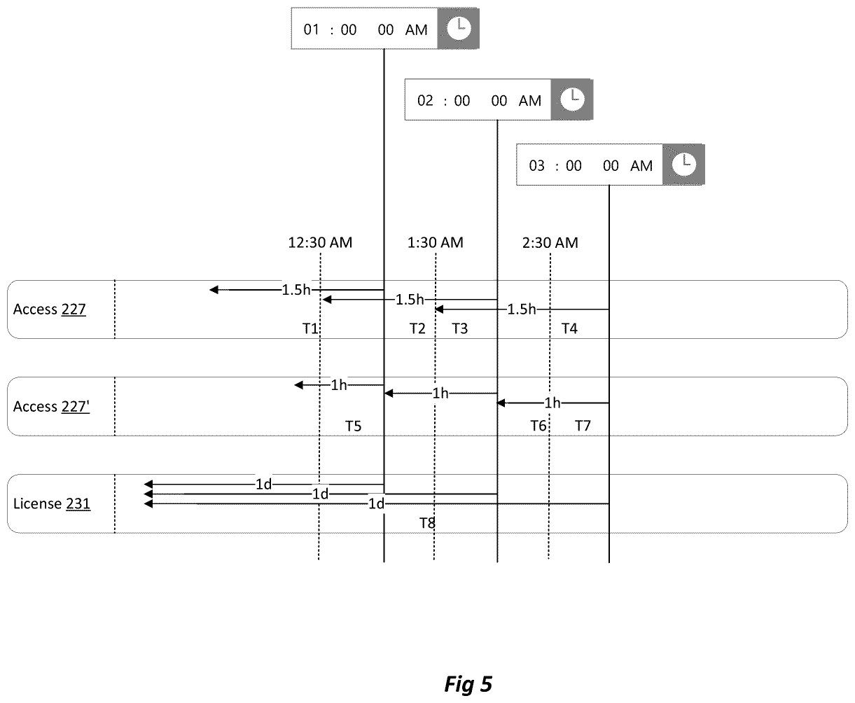

To illustrate an exemplary repeated execution, reference is made to FIG. 5 illustrating an example, according to certain embodiments of the presently disclosed subject matter. As shown in FIG. 5, three categories from the classification data structure 152 are illustrated, access 227, access 227′, and license 231. Tickets 1-8 were generated and are referenced by T1-T8 on the timelines, at the time they were generated in the categories to which they were classified. For example, ticket T1 was generated just before 12:30 pm and was classified by classifying module 322 to access 227 category. T2-T4 were generated later, and were also classified to access 227 category. T5-T7 were classified to access 227′ category. Ticket T8 was generated at about 1:30 pm and was classified classifying module 322 to license 231 category. Monitoring is scheduled to occur every round hour. The monitoring execution of the hours 1:00, 2:00, and 3:00 am are shown. For each category, a different time interval was predefined for monitoring history classification of tickets. As such, for access 227, a one-hour and a half (1.5 h) time interval was predefined. As such, during the monitoring execution which occurred at 1:00 am, monitoring module 323 will consider the parameters pertaining to ticket T1 only. At the execution of 3:00 am, monitoring module 323 will consider the parameters pertaining to tickets T3 and T4. For License 231 category, a one-day (1 d) time interval was predefined. As such, during the monitoring execution which occurred at 2:00 am and at 3:00 am, monitoring module 323 will consider the parameters pertaining to ticket T8 only. For each of the categories, monitoring module 323 may monitor the traffic of tickets, considering the predefined time interval, to identify a potential system-wide failure.

Referring back to FIG. 4, in some examples monitoring module 323 may consider the parameters pertaining to classification of the tickets in more than one classification category. With reference to the example of volume parameter, in case a spike is detected (illustrated by block 432), then an additional related category can be monitored (block 434). The additional category can be considered as related, e.g., if both categories are associated with components that are physically related to each, such as if both are hosted on the same server (or can be accessed by one or more components that are hosted on that server such as VPN server), or the access to both is similar or dependent on each other. Therefore, in cases where a server hosting several software components goes down, then the system 120 is likely to experience a large volume of tickets and even spikes, in associated categories in classification data structure 152. Therefore, if a spike is detected in one category, the monitoring module 323 can monitor at least one related category to detect a second spike. In response to detecting a second spike in the above example, it may be that a server has gone down, and a potential system-side failure is identified.

In some cases, prior to identifying the potential system-wide failure, monitoring module 323 can obtain additional indication from at least one component of the computerized system 120 (block 435). Optionally, obtaining additional indication can be performed following, and in response to detecting a spike in a certain category. Usually, monitoring module 323 will approach components configured to monitor processes running on the computerized system, such as the log analyzer 160, and to receive information which may be useful to determine whether a potential system-wide failure has occurred. For example, the log analyzer 160 can provide data comprising system logs, application logs, network logs, etc. In some examples, detection of a spike in a certain category can be combined with data from the log analyzer 160. In cases where data from the log analyzer 160 likewise indicates that a large volume of events has occurred in the software, then a potential system-wide failure can be identified. In some examples, the process can be a viewed as a bi-directional process. Both sides support the other but can function independently. On one hand, users 110 generate tickets pertaining to services, where these tickets reflect system failures, while on the other hand, a log monitoring system may or may not output logs that endorse the system failures reflected in the tickets. To illustrate, assume the following three scenarios:
1. The users 110 issue tickets that indicate that they have problems accessing Slack, Zoom and Outlook. In addition, a log on a server PROD-X01-EU indicates an error. All services mentioned from users 110 are deployed on this server. There is a high likelihood that a system-wide failure has occurred as indication is received from both the users 110 by the ticketing system, as well as from the logs.
2. A log on a server PROD-X01-EU outputs an error, yet the users 110 are yet influenced. However, the users 110 can proactively be notified that some specific services may experience problems. In this case, a system wide failure may have occurred, but the underline error doesn't necessary relate to the services it is running.
3. The users 110 issue tickets that indicate that they have problems accessing Slack, Zoom and Outlook, but no logs appearing on the server. The server can be more closely monitored, and an action can be taken even upon the first generated errors. Alternatively or additionally, it can be determined that a system-wide failure might have occurred, but the log was not programmed to catch specific malfunction case.

In some cases, in response to identifying a potential system-wide failure, alert module 324 can perform one or more actions (block 440). For example, alert module 324 can provide an alert to pre-defined IT support team members, including details of the category in which the anomaly was detected, results of monitoring other related categories, and any other information obtained from other components of the system following the monitoring. Alert module 324 can further identify all tickets related to the identified potential system-wide failure mark them as relating to a known system-wide failure, and transmit a suitable message to users 110 who generated these tickets, or alert all users 110 in the organization which use services pertaining to the potential system wide failure. Alert module 324 can further investigate whether a potential system failure has occurred, e.g., based on predefined rules, or take an action to solve it. For example, in case two spikes or more have been detected, and the categories are associated with components that are stored on a single server, then a predefined rule can include a resolution of this particular wide-system failure by rebooting the server. Users complaints on slowness in several services, automation may be to clear memory or cache, or even to upgrade the server resources.

Also, the nature of traffic of generated tickets in the current situation can be compared to previously occurred patterns, which are stored in storage unit 330. For example, historic past patterns such as nature of traffic of tickets generated in the ticketing system 140 and eventual resolution in the organization computerized system 120, or the eventual determination whether a system wide failure has occurred, can be stored in storage unit 330. When enough confirmed system-wide-failure cases have been accumulated in the storage unit 330 the monitoring module 323 may use the current information pertaining to the current potential system wide failure, in real time to correlate to any past saved patterns. If the recognized historical stored pattern led to a confirmed system wide failure is correlated with the current pattern (nature of traffic of generated tickets), it may anticipate something similar is about the current failure.

Attention is drawn to FIG. 6 illustrating a generalized flow-chart method 600 for facilitating identifying a system-wide failure in a computerized system, in accordance with certain embodiments of the presently disclosed subject matter. The operations of FIG. 6 are described with reference to elements of failure classification system 150. However, this is by no means binding, and the operations can be performed by elements other than those described herein.

The obtaining module 321 can obtain historical ticketing information, including a plurality of historical tickets and corresponding system failures that were eventually identified in computerized system 120 (block 610). The historical ticketing information and corresponding system failures can be stored and obtained, e.g., from storage unit 330. The historical tickets may include tickets previously generated by users 110 of the computerized system 120 in ticketing system 140. In similar manner to that described with respect to FIG. 4 and new tickets generated in ticketing system 140, the historical tickets can include data pertaining to the system failures, such as pre-existing categories included in a pre-existing ticketing data structure 142, title of the tickets, free text, priority, metadata and other information that can be extracted from each ticket.

The generation module 325 can process the ticketing information, and correlate the tickets with one or more classification categories (block 620). Each of the classification categories may be associated with a respective classification system failure.

In order to process the ticketing information, the historical ticketing information may undergo similar preprocessing as described above with respect to FIG. 4, and the data may be transformed and normalized using various functions (block 621). Numerical and categorical features may be included in textual features extracted from the historical ticketing information. The numerical and categorical features may be treated as textual feature, in this case they'll be added with the feature name and feature value as part of a specific template or prompt a long side the actual textual information such as description of a ticket. These features may be excluded from the ticket textual features and get filled with mean value if missing or inferred using additional AI model that is dedicated for that feature.

The transformed features of the historical ticketing information, resulted from the preprocessing process, may be fed to one or more self-supervised AI model. As described above, an embedding model to learn representations of the transformed features may be used (block 622), outputting high dimensional vectors for features. To obtain self-supervision each transformed feature X is processed in two functions f and g, through second transformation function, before or after processed by the model, depending on the native of function f(x)=z, and g(x)=z′. The embedded vector is the output of the last layer of the machine learning model (neural network model), the final output z and z′ are the input of the contrastive loss while the output of the neural network model's last normalized layer is the actual embedded vector that will be used in the clustering algorithm mention below.

In order to generate a hierarchical structure, relations between tickets can be determined. The hierarchical structure can be a separate structure or along with the pre-existing hierarchical structure. The pre-existing hierarchical structure can be used to “learn” the proximity or the relation of tickets as described above. The tickets can be represented as vectors, through the process of the embedding (block 622 above). The hierarchical structure may represent the relations between tickets, as follows: the “affinity” of two tickets may be the dot product, cosine distance, between them. Each ticket can be compared with another this generates (N*N−1)/2 couples where N is the number of embedded tickets/items. Then a Linkage matrix, consist of 4 columns may be formed. The first two columns are indices pointing to the embedded tickets, third column represents the distance (cosine distance) and the fourth represents the “merge” between them or the category in which the two indices should be merged. The linkage matrix may form the hierarchical structure of the tickets. For example, two separate branches can be generated, where each branch represents a category of tickets that meets an adequate threshold (distance). The process tries to connect similar tickets together. Once two tickets meet a threshold requirement they may be merged and they may be represented as one average so that the process can continue, until the root is formed (process is bottom up). The branches can be merged at a higher level of the hierarchy at a higher threshold. The Root of the tree includes all the tickets under one category, while at the “leaves” level each ticket may be associated with is its own category. The generated hierarchical structure can be in the form of a dendrogram.

Next, the embedding model may be trained using a contrastive loss function (block 623). The contrastive loss function may measure the similarity between pairs of vectors and to learn embeddings that are similar for semantically similar features, and dissimilar for semantically dissimilar features.

Function f(x) and g(x) slightly distort the original X. The contrastive loss is set to minimize the distance between f(x) and g(x) as they originated from the exact same feature of a ticket (self-supervision process). Example of f(x) and g(x): masks different tokens in the original processed textual features. The dataset may be expanded to have additional examples extracted from the predefined data structure where similar pairs is sampled from the same node/leaf in the data structure given they would undergo similar path in the lifecycle of the ticket and heuristically share the same characteristics, for example two tickets in the same node/leaf had the same agents or similar agents in their skills resolving them. Another heuristic is to take High Jaccard distance (Syntactically similar incidents). The contrastive loss can also be expanded to take negative examples by choosing two tickets that reside in different nodes/leaves in the data structure. The process of minimizing similar tickets while maximizing different tickets creates the desired embedded space.

Then, based on these embedded vectors a hierarchical clustering algorithm constructs the tree. The Hierarchical tree is created under each group in the data structure 142 given or selected by a user.

A similarity function can be used to measure the similarity between the vector representation of the features from the embedding model (block 624). For example, a distance metric, such as the Euclidean distance or the cosine similarity, can be used as a similarity function.

The next step is to classify the information based on the similarity between the vector representation (block 626). The information can be classified into any number of categories, such as the categories in level 4 in FIG. 2A.

The generation module 325 can then maintain a classification hierarchical failure data structure comprising the one or more classification categories (block 630). During a run-time process, when new tickets are generated and are classified into the categories, monitoring the categories and the tickets classified into these categories in the manner described above facilitates identification of a potential system-wide failure, e.g., by detecting an anomaly, as described above.

In some examples, the classification data structure 152 can be updated over time, e.g., based on new ticketing information.

In some examples, historical tickets can be generated by users of another, similar, computerized system. Computerized systems can be considered as similar if they include similar organization components 130, such that at least some of the components operated in the systems are identical, for example, two systems implementing office programs, financial programs, and messaging programs. In such cases, a generic classification hierarchical failure data structure can be generated for a second system, based on historical tickets generated by a first system. The generic data structure, constituting data structure 152 for the organization, can be implemented and used during run-time when new tickets are issued. Over time, the generic data structure 152 can be updated based on new tickets issued in the system to fine-tune the categories and adapt them to the actual organization components 130 and actual failures that have occurred in the organization.

It is noted that the teachings of the presently disclosed subject matter are not bound by the flow charts illustrated in FIGS. 4 and 6, and that the illustrated operations can occur out of the illustrated order.

It is noted that, as is well known in the art, systems operating in real time or near real time may experience some delay between the onset of a command and its execution, due to various reasons such as processing time and/or network communication delay. The term real-time as used herein is meant to include near real-time i.e., operation in systems that may experience some internal delays.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A computer-implemented method for identifying a potential system-wide failure in a computerized system, comprising:
receiving a plurality of tickets generated by users of the computerized system, wherein at least some of the tickets include data pertaining to system failures;
classifying, based on the data, at least some of the tickets to respective one or more classification categories included in a hierarchical failure classification data structure comprising a plurality of classification categories, wherein each of the categories is associated with a system failure, wherein the data structure was generated using machine learning techniques applied to historical ticketing information including a plurality of historical tickets and corresponding system failures;
monitoring the one or more categories to identify a potential system-wide failure; and
in response to identifying a potential system-wide failure, performing an action.

2. The method of claim 1, wherein the tickets are associated by the users with pre-existing categories included in a pre-existing hierarchical failure data structure comprising a plurality of pre-existing categories, each associated with a pre-defined system failure.

3. The method of claim 2, wherein the pre-existing ticketing data structure and the classification data structure are identical.

4. The method of claim 2, wherein at least one of the classification categories does not correspond to any of the pre-existing categories.

5. The method of claim 4, wherein monitoring at least some of the pre-existing categories is insufficient to identify a potential system-wide failure.

6. The method of claim 4, wherein the classification data structure comprises a plurality of hierarchical levels of main classification categories, each main category being associated with a respective main classification system failure, wherein at least one of the main classification categories in a top level has an associated plurality of related focused classification sub-categories in one or more lower levels, wherein at least one of the focused classification sub-categories is associated with a focused classification system failure, wherein at least one of the focused classification sub-categories does not correspond to any of the pre-existing categories.

7. The method of claim 1, wherein the classifying is performed using an Artificial Intelligence (AI) model.

8. The method of claim 1, wherein the classifying further comprises, for each ticket:
obtaining a confidence value indicative of the level of confidence that the ticket should be classified to the respective category;
obtaining a pre-defined threshold associated with the respective category; and
classifying the ticket to the category in response to the confidence level exceeding the predetermined threshold.

9. The method of claim 1, wherein the monitoring comprises:
determining values of one or more parameters pertaining to classification of the tickets to the at least one classification category;
based on the values, identifying a potential system-wide failure.

10. The method of claim 9, wherein the parameters are selected from a group comprising: volume, frequency, an hour of the day, and history of past tickets classified to the classification categories, one or more pre-defined rules, location in which the ticket was generated, or a combination thereof.

11. The method of claim 10, wherein the at least one parameter is the volume, and wherein identifying the potential system-wide failure comprises:
detecting an anomaly; and
identifying, based on the anomaly, the potential system-wide failure.

12. The method of claim 11, wherein the anomaly is a spike.

13. The method of claim 12, wherein, in response to detecting the spike, the method comprises:
monitoring at least one related category to detect a second spike; and
in response to detecting a second spike, identifying a potential system-wide failure.

14. The method of claim 1, wherein, prior to identifying the potential system-wide failure, the method further comprises:
in response to detecting the spike, obtaining additional indication from at least one component of the computerized system, configured to monitor processes running on the computerized system; and
identifying the potential system-wide failure, based on the spike and the additional indication.

15. The method of claim 1, wherein monitoring the categories is performed selectively.

16. The method of claim 1, wherein monitoring the categories is repeatedly performed.

17. The method of claim 16, wherein monitoring the categories is repeatedly performed based on a moving time interval.

18. The method of claim 1, wherein the data structure can be updated over time.

19. The method of claim 18, wherein the data structure is updated based on new ticketing information.

20. The method of claim 1, wherein the historical tickets are generated by users of the computerized system.

21. The method of claim 1, wherein the historical tickets are generated by other users of another, similar, computerized system.

22. A computer-implemented method for facilitating identifying a system-wide failure in a computerized system, comprising:
obtaining historical ticketing information including a plurality of historical tickets and corresponding system failures, wherein each of the historical tickets is generated by users of the computerized system and at least some of the historical tickets are associated by the users with pre-existing categories included in a pre-existing hierarchical failure data structure comprising a plurality of pre-existing categories, each associated with a pre-defined system failure;
using machine learning techniques applied to historical ticketing information to process the tickets and correlate them to one or more classification categories, wherein each of the classification categories is associated with a respective classification system failure; and
maintaining a classification hierarchical failure data structure comprising the one or more classification categories;
wherein monitoring the classification categories during a run-time process facilitates identification of a potential system-wide failure.

23. The method of claim 22, further comprising:
receiving new ticketing information pertaining to new tickets generated by users of the computerized system; and
updating the data structure based on the new ticketing information.

24. A computerized system for identifying a system-wide failure in a computerized system, the system comprising a processing and memory circuitry (PMC) configured to:
receive a plurality of tickets generated by users of the computerized system, wherein at least some of the tickets include data pertaining to system failures;
classify, based on the data, at least some of the tickets to respective one or more categories included in a hierarchical failure data structure comprising a plurality of categories, wherein each of the categories in the data structure is associated with a system failure, wherein the data structure is generated using machine learning techniques applied to historical ticketing information including a plurality of historical tickets and corresponding system failures;
monitor the respective one or more categories to identify a potential system-wide failure; and
in response to identifying a potential system-wide failure, performing an action.

25. A non-transitory computer readable storage medium tangibly embodying a program of instructions that, when executed by a computer, cause the computer to perform a method for identifying a system-wide failure in a computerized system, the method comprising:
receiving a plurality of tickets generated by users of the computerized system, wherein at least some of the tickets include data pertaining to system failures;
classifying, based on the data, at least some of the tickets to respective one or more categories included in a hierarchical failure data structure comprising a plurality of categories, wherein each of the categories in the data structure is associated with a system failure, wherein the data structure is generated using machine learning techniques applied to historical ticketing information including a plurality of historical tickets and corresponding system failures;
monitoring the respective one or more categories to identify a potential system-wide failure; and
in response to identifying a potential system-wide failure, performing an action.
